(19) United States
(12) Patent Application Publication
(10) Pub. No.: US 2016/0372258 A1
(43) Pub. Date: Dec. 22, 2016

(54) BURIED INDUCTIVE ELEMENT STRUCTURE OF SLIM TYPE

(71) Applicant: YUN-KUANG FAN, Taoyuan (TW)

(72) Inventor: YUN-KUANG FAN, Taoyuan (TW)

(21) Appl. No.: 14/742,125

(22) Filed: Jun. 17, 2015

(51) Int. Cl. H01F 27/29; H01F 27/40

(52) U.S. Cl. CPC H01F 27/29; H01F 27/40

(57) ABSTRACT

A buried inductive element structure includes a base substrate having a flat upper surface defining a reception space, a coil disposed securely with the space, and an electronic component disposed in the reception space at one side of the coil. The substrate further includes two terminals having two lower barbed sections consisting of buried parts buried within the upper surface and connecting parts exposed from the upper surface and two upper curved sections exposed to an exterior of the substrate. The coil has two ends connected electrically and respectively to the upper curved sections of the terminals. The electronic component is connected electrically to the connecting parts of the two terminals. The substrate further includes a pair of pedestals upon which the two terminals are mounted respectively such that the pedestals are disposed on the upper surface of the substrate at two opposite sides of the coil.

### BACKGROUND OF THE INVENTION

1. Field of the Invention

The present invention relates to an element connecting structure, more particularly to a buried inductive element structure of slim type including a base substrate in which at least two electronic components are buried so as to facilitate designing compact basic circuits within an electronic device, thereby increasing the layout of circuit density and electronic elements in an electronic device.

2. The Prior Arts

Sizes shrink is the major trench in the integrated circuit fabrication field in order to produce compact electronic devices so that plug-in type electronic components implemented within the electronic devices are gradually replaced by SMD (Surface Mount Devices).

FIG. 1 shows a conventional surface mount device, such as an inductive element, which is generally I-shaped including a central core 1 constituted by an upper flange 11, an intermediate part 14 and a lower flange 12. The upper and lower flanges 11, 12 are formed with a pair of notches 111, 111′, 121, 121′ respectively while a pair of recesses 13 are formed on an upper surface of the upper flange 11 proximate to the notches 111, 111′ respectively. Moreover, a silver layer (not visible) is coated over the upper surface of the upper flange 11 such that after winding turns of a wire coil 2 are wrapped around the intermediate part 14, the opposite ends 21, 22 of the wire coil 2 passed through the notches 111, 111′ are bent into the recesses 13 respectively and are soldered to the silver layer through soldering process, thereby securing the ends 21, 22 of the wire coil 2 within the recesses 13 and connected to the silver layer on the upper surface 11 of the central core 1.

The above SMD has a relatively small height or thickness when compared to a plug-in element, but handheld mobile devices are in the trend of sizes shrink such that said SMD is not suitable to be implemented in a handheld mobile device owing to its configuration as best shown in FIG. 1, since the total thickness of the inductive element cannot be restricted below 2 mm.

Moreover, in FIG. 1, it is required to apply manually a solder paste in order to form the silver layer and the opposite ends 21, 22 of the wire coil 2 still require manual labor to be bent into the recess 13 only then can be fixed on the silver layer through tin soldering process 16. The inductive element produced as stated above then can be applied in a printed circuit board and can establish electrical connection with the circuits of the circuit board.

For a wound-type inductive element, winding turns of the wire coil are required to be wrapped around a central core such that the wound-type inductive element does not provide vacuum suction means or planar surface for gripping operations. Hence, mounting of the inductive element relative to a printed circuit board is conducted via manual soldering process. No automatic machines or devices can be used when mounting such type of inductive element in the circuit board, which in turn, hinders high mass production of low cost printed circuits. Manual soldering process causes non-precision and tolerance error among the electronic components.

Since winding turns of the wire coil 2 are wrapped only around the intermediate part 14 of the central core 1 (leaving the other un-wrapped parts), the inductance capacity thereof cannot be increased owing to restriction in the number of winding turns of the wire coil 2. In addition, since the currently available inductive elements are complicated in structures, the manufacturing cost the same is hard to be reduced.

The applicant has in Taiwan Patent Published No. M490096 proposed an inductive element of slim type with the intention and design of reducing the total thickness, in which, the wire coil is disposed in a reception chamber of the base substrate, thereby achieving in reduced thickness and increasing the inductance capacity. However, the inductive element in the circuit path must integrate with other electronic elements for performing filtering, oscillating, phase shifting or resonant modulating etc, as multiple circuits.

Unlike to the prior art single integrated element, where only an inductive element is disposed in the base substrate while the other electronic components occupy the receiving space in the circuit board, it is highly desired to develop an active or passive type inductive element structure of slim size including a base substrate constituted by at least two electronic components so as to enhence the circuit layout within an electronic device, thereby enabling the electronic device to posses finer circuit density, reducing the occupied space but providing higher function features.

### SUMMARY OF THE INVENTION

Therefore, the objective of the present invention is to provide an element connecting structure, which is simple in structure and which costs lesser manufacturing expense in the mass production and hence providing high yield.

Another objective of the present invention is to provide a buried inductive element structure of slim type which is suitable to be implemented in handheld electronic devices with sizes shrink, where electronic components in the electronic devices occupy lesser space so as to enhance and facilitate layout of circuit paths within the mobile devices for providing more function features.

A buried inductive element structure of the present invention includes a base substrate having a flat upper surface defining a reception space confined by a chamber, the base substrate including two terminals having two lower barbed sections consisting of buried parts buried within the upper surface and connecting parts exposed from the upper surface and two upper curved sections exposed to an exterior of the base substrate; a coil disposed securely with the reception space, having two opposite ends connected electrically and respectively to the upper curved sections of the two terminals; and an electronic component disposed in the reception space at one side of the coil and connected electrically to the connecting parts of the two terminals. The base substrate further includes at least a pair of pedestals, upon which the two terminals are mounted respectively such that the pedestals are disposed on the upper surface of the base substrate at two opposite sides of the coil.

One distinct feature of the present invention resides in that the coil and the electronic component can be disposed within the reception chamber of the base substrate in an overlap manner or side-by-side manner and they can be coupled electrically with the terminals in series or parallel, thereby providing multiple basic circuit paths, such as in case the electronic component is a resistor, the buried inductive element structure integrates with the resistor to form a resistor-inductor circuit and in case the electronic component is a capacitor, the buried inductive element structure integrates with the capacitor to form a capacitor-inductor circuit for serving as a resonant circuit, a filtering circuit or phase shift circuit and other circuit paths.

Another distinct feature of the present invention resides in that since the reception chamber of the base substrate can accommodate one or several components, by providing two pedestals at appropriate positions of the base substrate, the buried inductive element structure thus formed occupies a thickness or height less than 2 mm, hence the element connecting structure has tremendously small thickness. In case, a wire coil is implemented, the inductance capacity thereof may exceed greater than 100 μH. The buried inductive element structure of the present invention is highly suitable for electronic devices of sizes shrink, since the same occupies only a little space in the electronic devices, which in turn, facilitates in circuit layout in the electronic devices.

Since the buried inductive element structure of the present invention is simple in structure, the mass production cost thereof is reduced, especially owing to pre-setting of terminals on the base substrate, the wire coil and the electronic component can be easily disposed in the reception chamber during the actual assembly of the inductive element structure of the present invention. Hence, high yield is achieved during the mass production.

The base substrate of the present invention has a flat upper surface for the wire coil such that automatic machines like vacuum suction means or gripping apparatuses can be applied to moving the same so as to facilitate precise and quick soldering onto a printed circuit board, hence providing high mass production with fine quality precision position among the elements.

Therefore, the buried inductive element structure of the present invention is suitable to be implemented in a handheld mobile device of slim type since it occupies little space, which in turn, results in extra space for layout of circuits in the printed circuit board in a flexible manner, thereby providing high circuit density to provide fine performance or functions.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 shows a perspective view of an inductive element of SMD (Surface Mount Device) type of prior art;

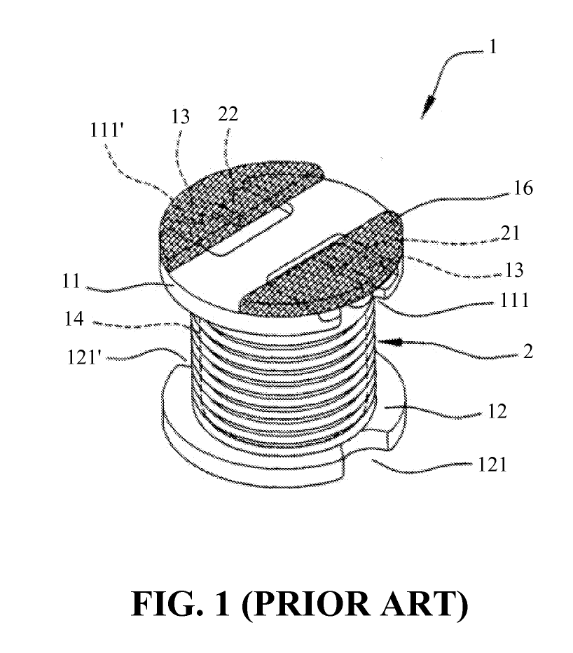

FIG. 2 shows an exploded and perspective view of the first preferred embodiment of a buried inductive element structure of slim type according to the present invention;

FIG. 3 shows a perspective view of a terminal employed in the buried inductive element structure of slim type according to the present invention;

FIG. 4 shows an exploded view of the buried inductive element structure of slim type according to the present invention, illustrating a wire coil of generally I-shaped;

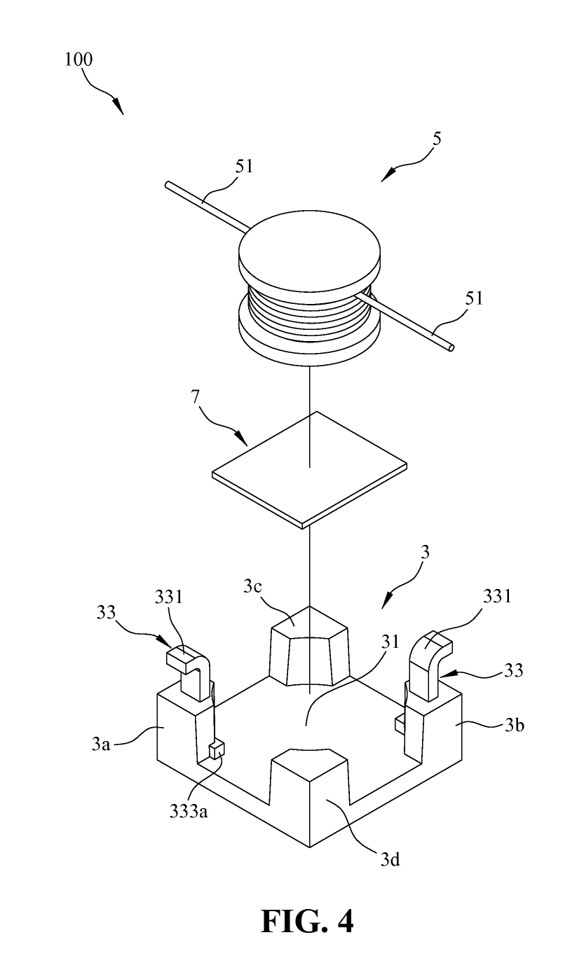

FIG. 5 shows a cross sectional view of the first preferred embodiment of the buried inductive element structure of slim type according to the present invention;

FIG. 6A shows an exploded and perspective view of the second preferred embodiment of the buried inductive element structure of slim type according to the present invention;

FIG. 6B shows an exploded and perspective view of the third preferred embodiment of the buried inductive element structure of slim type according to the present invention;

FIG. 6C shows an exploded and perspective view of the fourth preferred embodiment of the buried inductive element structure of slim type according to the present invention;

FIG. 6D shows an exploded and perspective view of the fifth preferred embodiment of the buried inductive element structure of slim type according to the present invention;

FIG. 6E shows an exploded and perspective view of the sixth preferred embodiment of the buried inductive element structure of slim type according to the present invention;

FIG. 7A shows an exploded and perspective view of the seventh preferred embodiment of the buried inductive element structure of slim type according to the present invention;

FIG. 7B shows an exploded and perspective view of the eighth preferred embodiment of the buried inductive element structure of slim type according to the present invention; and

FIG. 8 shows an exploded and perspective view of the ninth preferred embodiment of the buried inductive element structure of slim type according to the present invention.

### DETAILED DESCRIPTION OF THE PREFERRED EMBODIMENTS

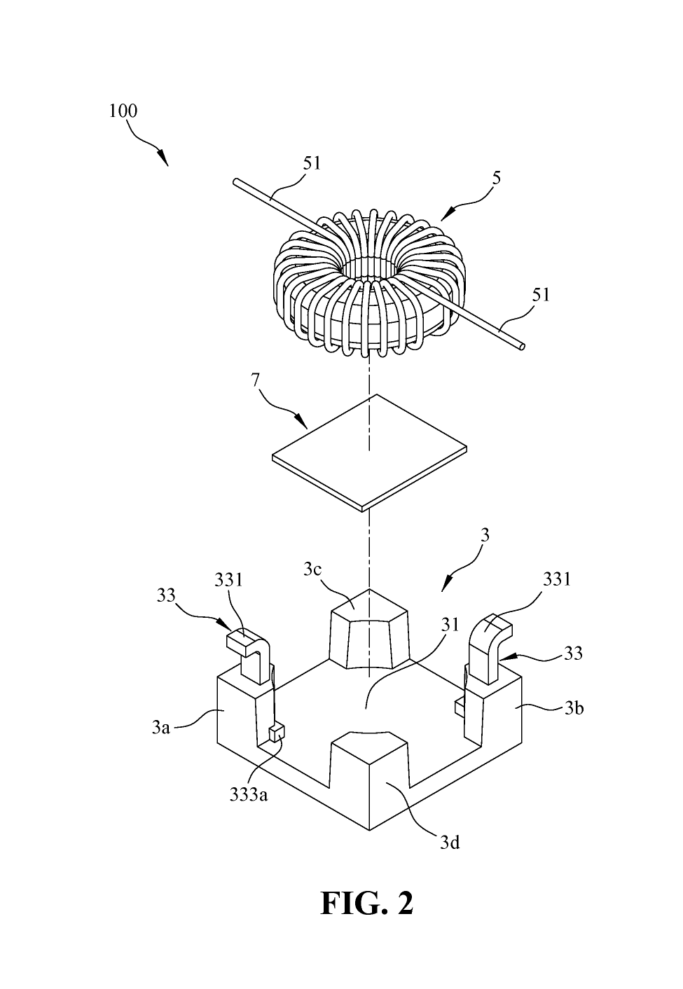

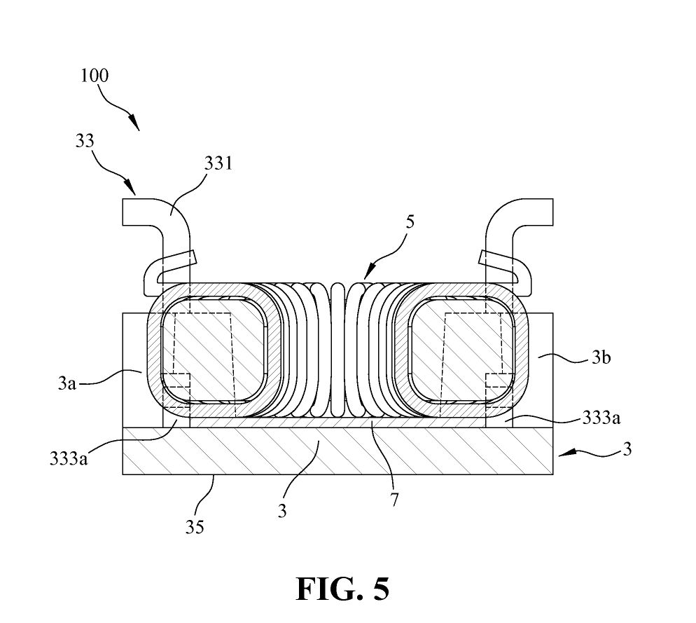

FIG. 2 shows an exploded and perspective view of the first preferred embodiment of a buried inductive element structure of slim type according to the present invention while FIG. 5 shows a cross sectional view of the first preferred embodiment of the buried inductive element structure of slim type according to the present invention. As illustrated, the inductive element structure 100 of the present invention includes a base substrate 3, a wire coil 5 and an electronic component 7, wherein the base substrate 3 has a flat upper surface defining a reception space 31 confined by a chamber, and two terminals 33 at two opposite corners thereof. Preferably, the base substrate 3 is made from insulated materials while the inner peripheral wall confining the reception space 31 is annular with or without disconnected parts. In this embodiment, the reception space 31 is defined by four annular wall parts, as best shown in FIG. 2.

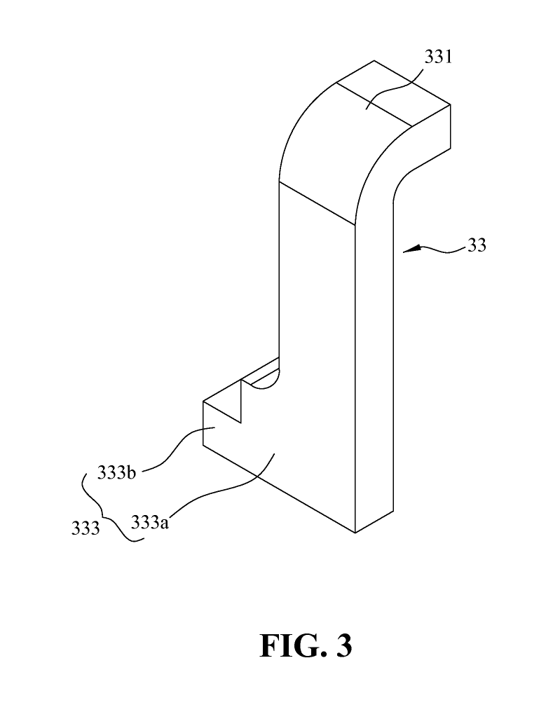

FIG. 3 shows a perspective view of a terminal employed in the buried inductive element structure of slim type according to the present invention. Also referring to FIG. 2, the two terminals 33 have two lower barbed sections 333 consisting of buried parts 333b buried within the upper surface of the base substrate 3 and connecting parts 333a exposed from the upper surface of the base substrate 3 and two upper curved sections 331 exposed to an exterior of the base substrate 3.

Referring to FIGS. 2 and 5, the wire coil 5 is disposed securely within the reception space 31, has two opposite ends 51 connected electrically and respectively to the upper curved sections 331 of the two terminals 33. The electronic component 7 is disposed in the reception space 31 at one planar side of the coil 5 and is connected electrically to the connecting parts 333a of the two terminals 33. Preferably, the electronic component 7 is selected from a group consisting of a capacitor, a resistor and an inductor or other appropriate electronic elements.

In this embodiment, the wire coil 5 and the electronic component 7 are installed securely in the reception space 31 of the base substrate 3 via soldering process (not shown) or dispensing means. To be more specific, the soldering process is conducted on the wire coil 5 or one side surface of the electronic component 7 with respect to the reception space 31 of the base substrate 3 for securing the coil 5 and the electronic component 7 within the reception space 31.

In this preferred embodiment, the electronic component 7 is disposed below the wire coil 5 (see FIG. 5) or above the wire coil 5, front and rear side of the wire coil 5 depending on the requirement of the actual applications and their relative position relationship is not the feature of the present invention, such that the detailed description is omitted herein for the sake of brevity.

Preferably, the base substrate 3 is rectangular, circular, triangular polygonal or other geometrical configurations. The above base substrate 3 is shown in rectangular to facilitate explanation and better understanding of the present invention.

Referring again to FIG. 2, the base substrate 3 further includes at least a pair of pedestals 3a, 3b upon which the two terminals 33 are mounted respectively such that the pedestals 3a, 3b are disposed on the upper surface of the base substrate 3 at two opposite sides of the coil 5. To be more specific, the pedestals 3a, 3b projects upward or vertically from the upper surface at two diagonal positions of the base substrate 3.

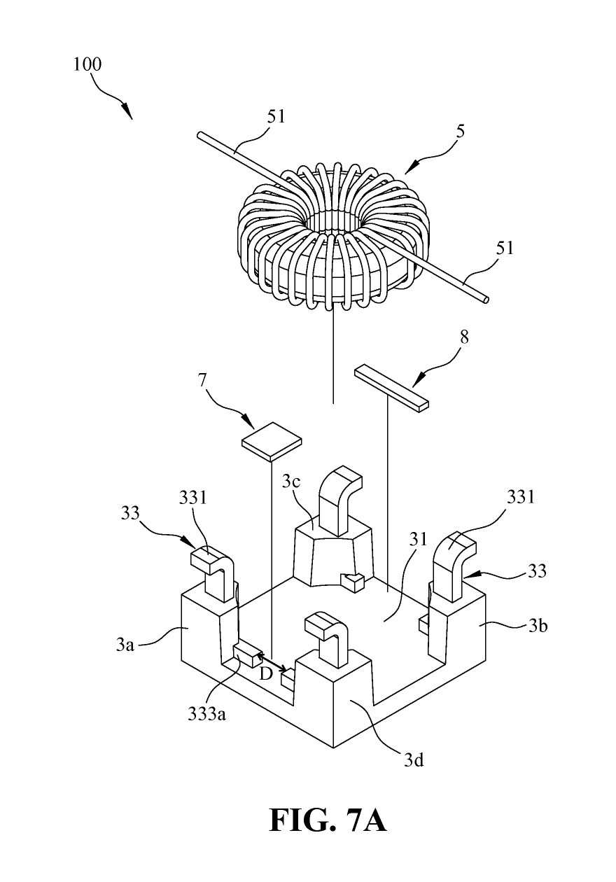

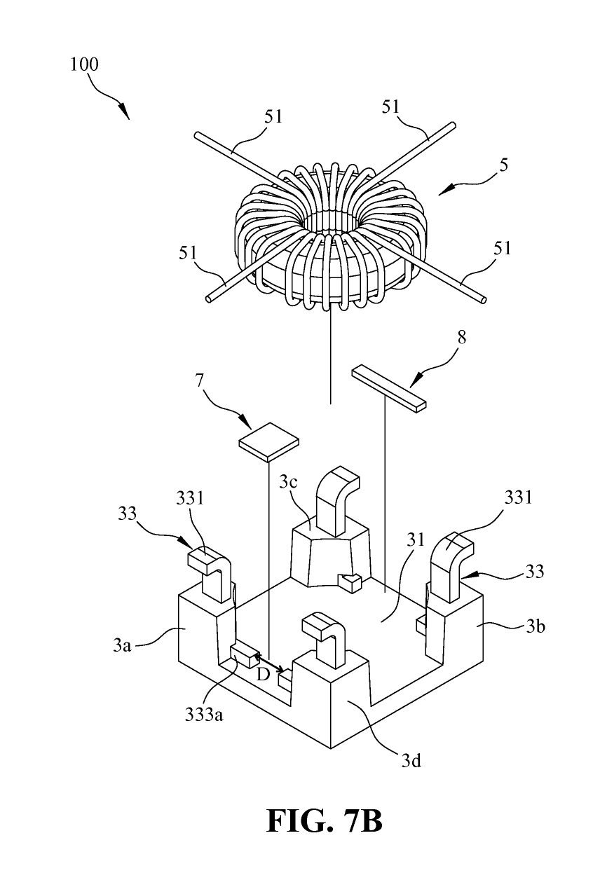

In one preferred embodiment of the present invention, the buried inductive element structure 100 further includes an extra electronic component 8 (see FIG. 7B) while the base substrate 3 further includes an extra pair of pedestals 3c, 3d upon which another two terminals 33 are mounted respectively and such that the extra electronic component 8 is connected electrically with the another two terminals 33 respectively.

The previously stated pedestals 3a, 3b, 3c, 3d projects upward or vertically from four corners of the base substrate 3 such that the connecting parts 333a of the terminals 33 are exposed from the pedestals 3a, 3b, 3c, 3d respectively so as to be exposed from the upper surface of the base substrate 3.

Each of the pedestals 3a, 3b, 3c, 3d is provided with one terminal 33 while the wire coil 5 has two pair of opposite ends 51 for connecting electrically to four terminals 33 to facilitate the soldering process and to reduce the thickness of the coil 5 and the electronic component after assembly such that the four barbed sections 333 of the terminals 33 located densely and closely on the base substrate 3.

Preferably, the chamber 31 is defined by four the pedestals 3a, 3b, 3c, 3d, thereby forming four gaps between an adjacent pair of the pedestals 3a, 3b, 3c, 3d, which in turn, reduce the material for formation of the chamber 31. The number of the pedestals 3a, 3b, 3c, 3d should not be restricted only to four, and should depend on the actual requirement of the desired product.

One distinct feature of the present invention resides in that owing to presence of the reception chamber 31 of the base substrate 3, the coil 5 and the electronic component 7 can be disposed within the reception chamber in an overlap manner or side-by-side manner and they can be coupled electrically with the terminals 33 in series or parallel, thereby providing multiple basic circuit paths, such as in case the electronic component is a resistor, the buried inductive element structure 100 of the present invention integrates with the resistor to form a resistor-inductor circuit and in case the electronic component is a capacitor, the buried inductive element structure 100 of the present invention integrates with the capacitor to form a capacitor-inductor circuit for serving as a resonant circuit, a filtering circuit or phase shift circuit and other circuit paths.

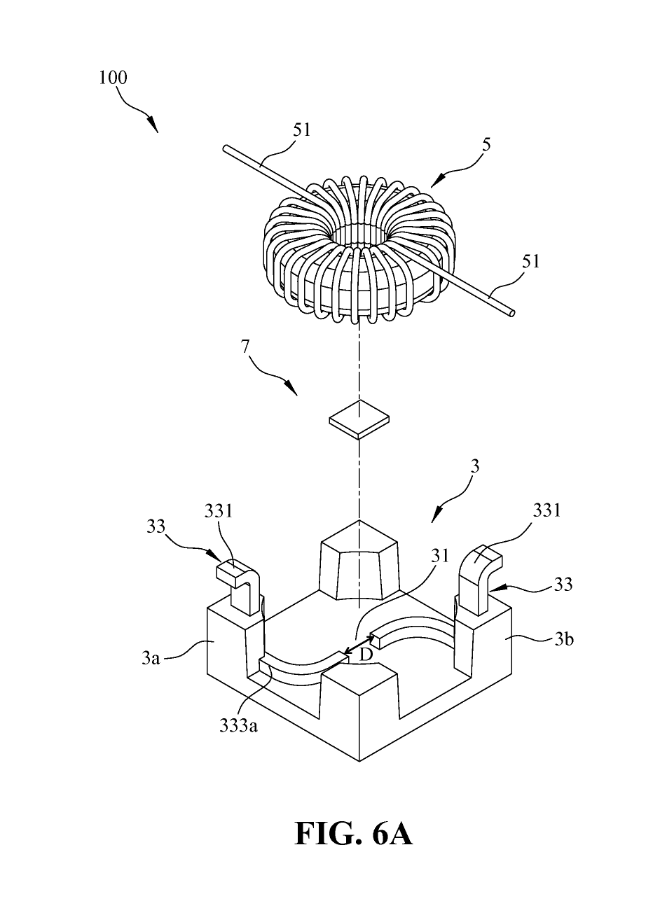

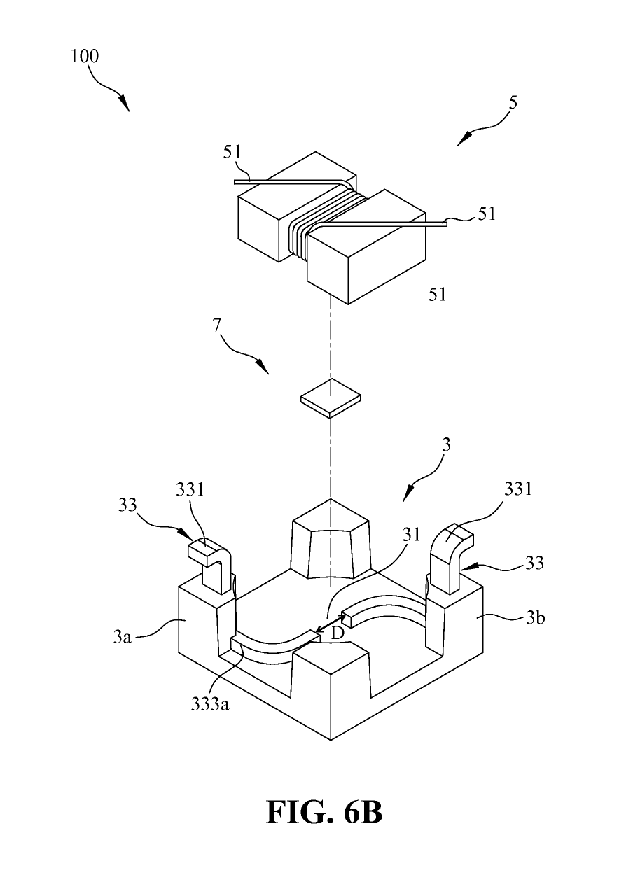

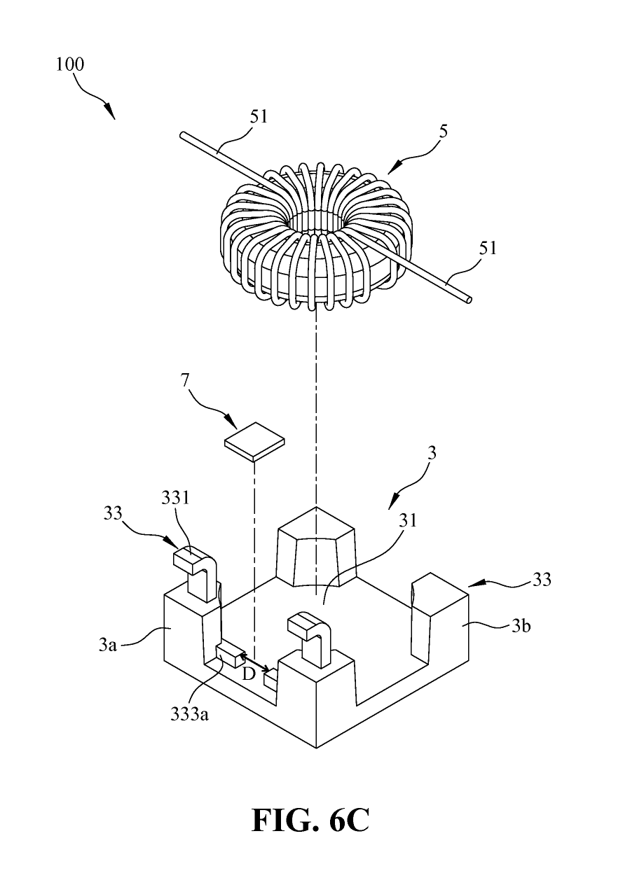

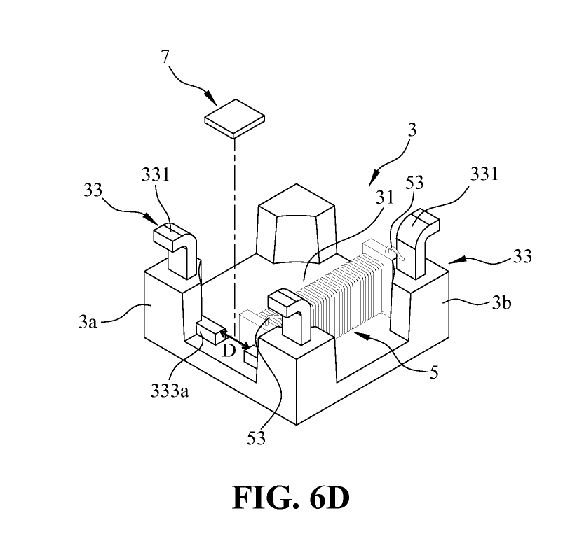

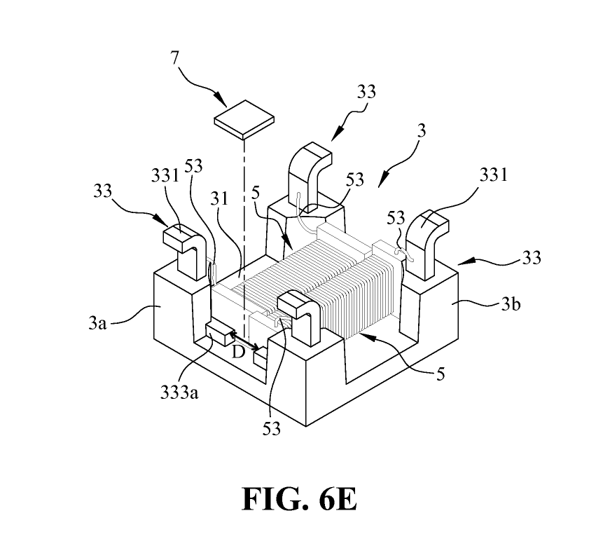

Referring to FIGS. 6A-6D, wherein FIG. 6A shows an exploded and perspective view of the second preferred embodiment of the buried inductive element structure of slim type according to the present invention; FIG. 6B shows an exploded and perspective view of the third preferred embodiment of the buried inductive element structure of slim type according to the present invention; FIG. 6C shows an exploded and perspective view of the fourth preferred embodiment of the buried inductive element structure of slim type according to the present invention; and FIG. 6D shows an exploded and perspective view of the fifth preferred embodiment of the buried inductive element structure of slim type according to the present invention. As illustrated in FIG. 6A, the inductive element structure 100 of the present invention includes at least a base substrate 3 and a wire coil 5, their structures are similar to the first embodiment in general except that the connecting parts 333a of the terminals 33 are generally curved to possess free ends aligned with each other and define a gap D therebetween so that a magnetic field with storage capacity is generated at the gap.

Note that the above two terminals 33 are disposed on the base substrate 3 at diagonal position relative to each other (see FIG. 6A). Preferably, a wire coil 5 having low inductance capacity with I-shaped core is implemented as shown in FIG. 6B or the two terminals 33 are mounted on adjacent pair of the pedestals 3a aligned relative to each other so does the connecting parts 333a of the terminals 33 as best shown in FIG. 6C. FIG. 6D shows the wire coil 5 and the electronic component 7 are disposed side-by-side in the chamber 31 while the I-shaped core itself has two opposite ends respectively provided with connecting terminals 53 for establishing electrical communication with the terminals 33. To be more specific, suitable soldering process is conducted to electrically connecting the connecting terminals 53 of the coil 5 to the terminals 33.

FIG. 6E shows an exploded and perspective view of the sixth preferred embodiment of the buried inductive element structure of slim type according to the present invention. The only difference relative to the previous embodiment resides in that two units of coils 5 with I-shaped cores are implemented one in erected posture while the other one in flat posture within the reception chamber 31.

In the second and third preferred embodiments of the present invention, the electronic component 7 is disposed in the reception chamber 31 at one side of the coil 5 and is connected electrically to two connecting parts 333a of the terminals 33, which are disposed diagonally relative to each other on the base substrate 3.

When a current is applied to the terminals 33 in case of operation, a magnetic field is generated between two spaced apart connecting parts 333a at the gap D since the latter serves as insulated medium (the atmosphere), thereby providing the inductance effects and eliminating presence of an actual inductor. Of course, the electronic component 7 (like a capacitor) can be coupled electrically to the connecting parts 333a of the terminals 33 so as to provide other specific feature (such as different inductance capacity).

Therefore, the buried inductive element structure 100 of the present invention can provide small and large inductance capacity and is suitable be implemented in different handheld mobile devices.

FIG. 7A shows an exploded and perspective view of the seventh preferred embodiment of the buried inductive element structure of slim type according to the present invention and has the structure similar to that of FIG. 6A, except that the seventh embodiment further includes an extra electronic component 8 while the base substrate 3 further includes an extra pair of pedestals 3c, 3d upon which another two terminals 33 are mounted respectively and such that the extra electronic component 8 is connected electrically with the another two terminals 33 respectively. Preferably, the extra electronic component 8 is selected from a group consisting of a capacitor, a resistor and an inductor or other electronic elements.

One distinct feature of the present invention is that several circuits like RLC circuit (also known as resonant or tuned circuit), CLC (capacitor-inductor-capacitor) filtering circuit, and LCL (inductor-capacitor-inductor) filtering circuit can be constructed through the fourth embodiment with at least one wire coil.

FIG. 7B shows an exploded and perspective view of the eighth preferred embodiment of the buried inductive element structure of slim type according to the present invention, in which two pairs of opposite ends of the wire coil 5 are connected electrically to the electronic components 7 and 8 respectively so as to form two independent parallel circuits, like RL (resistor-inductor circuit) and LC (inductor-capacitor circuit) circuits.

In these preferred embodiments, the wire coil 5 is simply an annular wire coil or preferably an I-shaped such that inner wall surface of the chamber 31 or the pedestals 3a, 3b, 3c, 3d should be curved to fittingly contact the periphery the wire coil 5 so as to enhance securing of the latter within the chamber 31. Note that the configurations of the wire coil 5, the electronic component 7 and the chamber 31 are used only to describe and explain the concept of the present invention so that these configurations should not restrict the claim scope of the buried inductive element structure of the present invention.

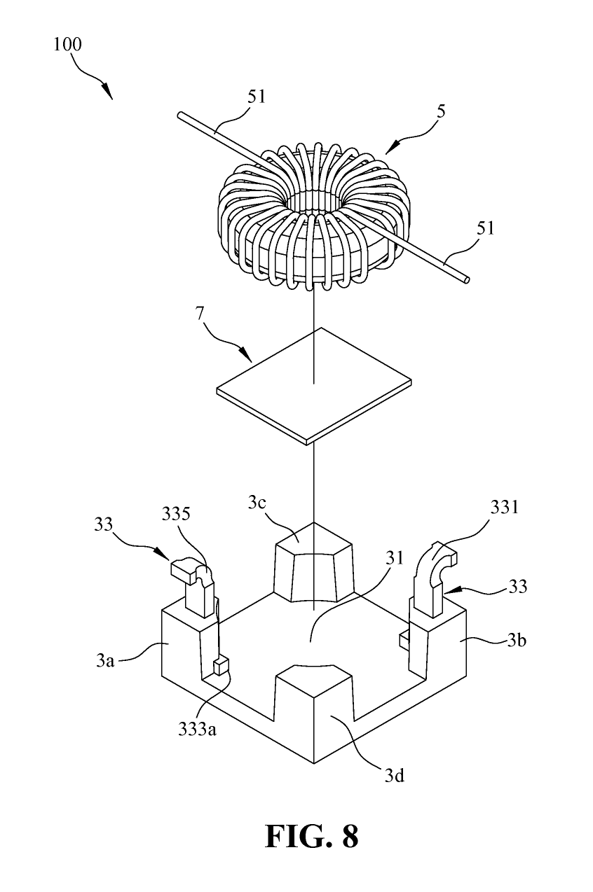

FIG. 8 shows an exploded and perspective view of the ninth preferred embodiment of the buried inductive element structure of slim type according to the present invention and has the structure similar to the first preferred embodiment except that the upper curved section 331 of each of the terminals 33 is formed with a constricted portion 335 to permit winding of a respective one of said opposite ends 51 of said coil 5 so as to prevent movement of the wire coil 5 during the winding process relative to the terminals 33.

The distinct features of the present invention further includes since the base substrate 3 can define one or more than one chambers 31 and since the terminals 33 can be erected at appropriate location, the buried inductive element structure thus produced has a thickness lower than 2 mm. Hence the handheld mobile device implementing the same is relatively shrunk in size owing to occupation of little space therein and the annular wire coil provides inductance capacity greater than 100 μH. In other words, the buried inductive element structure of the present invention facilitates finer layout of circuit paths in the electronic device using the same.

Owing to possess of one planar side 35 of the wire coil 5 relative to the base substrate 3 such that automatic machines like vacuum suction means or gripping apparatuses can be applied to moving the same so as to facilitate precise and quick soldering onto a printed circuit board, hence providing high mass production with fine quality precision position among the elements.

In addition, the I-shaped core 1 of the wire core 5 permits wrapping of winding turns thereon, and the increased number of winding turns within the chamber 31 can induce higher inductance capacity,

Another distinct feature of the present invention resides in that since the buried inductive element structure is simple in structure which costs lesser manufacturing expense in the mass production and hence providing high yield. Because, one pair of terminals 33 is mounted in advance, during the actual assembly, only the wire coil 5 and the electronic component 7 need to be assembled, thereby facilitating in mass production of the devices implementing the same.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A buried inductive element structure comprising:
a base substrate having a flat upper surface defining a chamber with a reception space, said base substrate including two terminals having two lower barbed sections consisting of buried parts buried within said upper surface and connecting parts exposed from said upper surface and two upper curved sections exposed to an exterior of said base substrate;
a coil disposed securely within said reception space, having two opposite ends connected electrically and respectively to said upper curved sections of said two terminals; and
an electronic component disposed in said reception space at one side of said coil and connected electrically to said connecting parts of said two terminals;
wherein said base substrate further includes at least a pair of pedestals upon which said two terminals are mounted respectively such that said pedestals are disposed on said upper surface of said base substrate at two opposite sides of said coil.

2. The buried inductive element structure according to claim 1, wherein said coil or said electronic component is disposed securely in said reception space via dispensing means.

3. The buried inductive element structure according to claim 1, wherein said electronic component is selected from a group consisting of a capacitor, a resistor and an inductor.

4. The buried inductive element structure according to claim 1, wherein said two terminals are mounted respectively on said two pedestals at two diagonal positions of said upper surface.

5. The buried inductive element structure according to claim 1, wherein said coil includes a plurality of winding turns while said chamber having an annular inner wall defining said reception space and complementing with said winding turns, or said coil being generally I-shaped and having said opposite ends connected electrically with said terminals respectively.

6. The buried inductive element structure according to claim 1, wherein said upper curved section of each of said terminals is formed with a constricted portion to permit winding of a respective one of said opposite ends of said coil.

7. The buried inductive element structure according to claim 1, further comprising an extra electronic component, said base substrate further including an extra pair of pedestals upon which another two terminals are mounted respectively and such that said extra electronic component is connected electrically with said another two terminals respectively.

8. A buried inductive element structure comprising:
a base substrate having an flat upper surface defining a chamber with a reception space, said base substrate including two terminals having two lower barbed sections consisting of buried parts buried within said upper surface and connecting parts exposed from said upper surface and two upper curved sections exposed to an exterior of said base substrate; and
a coil disposed securely with said reception space, having two opposite ends connected electrically and respectively to said upper curved sections of said two terminals;
wherein, said base substrate further includes at least a pair of pedestals upon which said two terminals are mounted respectively such that said pedestals are disposed on said upper surface of said base substrate at two opposite sides of said coil while said connecting parts of said terminals define a gap therebetween.

9. The buried inductive element structure according to claim 8, further comprising:
an electronic component disposed in said reception space at one side of said coil and connected electrically to said connecting parts of said two terminals.

10. The buried inductive element structure according to claim 8, further comprising an extra electronic component, said base substrate further including an extra pair of pedestals upon which another two terminals are mounted respectively and such that said extra electronic component is connected electrically with said another two terminals respectively.
